(19) United States
(12) Patent Application Publication
(10) Pub. No.: US 2021/0182949 A1
(43) Pub. Date: Jun. 17, 2021

(54) SYSTEM AND PROCESS FOR DESIGN OF WEARABLE ARTICLES AND ACCESSORIES

(71) Applicant: Master Dynamic Limited, Pak Shek Kok (HK)

(72) Inventors: Ian KWAN, Pak Shek Kok (HK); Ching Tom KONG, Pak Shek Kok (HK); Wing Chiu LIU, Pak Shek Kok (HK)

(73) Assignee: Master Dynamic Limited, Pak Shek Kok (HK)

(21) Appl. No.: 17/189,089

(22) Filed: Mar. 1, 2021

Related U.S. Application Data
(63) Continuation of application No. 16/469,602, filed on Jun. 13, 2019, now abandoned.

(30) Foreign Application Priority Data
Dec. 16, 2016 (HK) 16114385.6

(51) Int. Cl. G06Q 30/06; G06F 16/903; G06F 16/9035

(52) U.S. Cl. CPC G06Q 30/0643; G06F 16/90335; G06F 17/15; G06Q 30/0627; G06Q 30/0635; G06F 16/9035

(57) ABSTRACT

A process operable uses a computerized system for displaying an article from a set of wearable articles or accessories. The article is displayed based upon a correlation between data indicative of features of mental impression of an article and the displayed article, and the computerized system includes a touch sensitive input device, a process module and a visual display module operably interconnected together via a communication link. The process includes the steps of (1) entering via a touch sensitive input device a first visual representation indicative of at least a portion of a mental impression of an article, wherein the first visual representation is a two-dimensional representation in a first predetermined viewing plane; (ii) in a processor module, comparing during step (i) data derived from input of the first visual representation and other data sets; and (iii) displaying on a visual display module a visual representation of at least a first article corresponding to the other data sets.

### CROSS REFERENCE TO RELATED APPLICATIONS

This application is a continuation of U.S. patent application Ser. No. 16/469,602, filed Jun. 13, 2019 and entitled SYSTEM AND PROCESS FOR DESIGN OF WEARABLE ARTICLES AND ACCESSORIES, which is incorporated herein by reference in its entirety for all purposes.

### TECHNICAL FIELD

The present invention relates to a system and process for design of wearable articles and accessories. More particularly, the present invention provides a system and process for assisting a user design of wearable articles and accessories.

### BACKGROUND OF THE INVENTION

The design of wearable articles and accessories is provided by designers based upon perceived or provided design requirements of the market, consumers or customers.

Such wearable articles include clothing and apparel, footwear, headgears, hats and the like, and such accessories include jewelry, articles of adornment, handbags, belts and the like.

Requirements and parameters as utilized in wearable articles and accessories may be based on functional requirements, aesthetics, fashion, existing design elements or attributes, materials, market trends and combinations thereof.

Such design may be provided by designers themselves, responsive to designers' perceived impression of the requirement of the market, from design requests and input from manufactures or retailers, from customer request, or based upon market research.

Design may be effected by dynamic interaction between a designer and a third party, with iterations provided throughout the design process based upon designer's knowledge as to the feasibility of design of an article, as well as functional and/or aesthetic input from the third party. This process can be complex as well as frustrating due to disconnections between the designer and the third party due to differences in design philosophy as well as differences in personal perception as to the manner in which an article may appear.

Design is often based on usage of pre-existing design elements which are known within the market, and which are known to meet market expectation, and often are provided in a number of forms, and the usage, selection and stylization of such design elements can provide articles having vastly or subtly varying visual effects, depending upon personal choice and subjective appeal.

In such design processes, there may be bespoke custom design, whereby designers design wearable articles and accessories based upon designers' product knowledge and third party knowledge and perception, or made by assembly of known design elements within the relevant art, which may vary based upon a fundamental form or variations thereof.

Within the art there exist systems and processes often called customization systems, which are based upon a process of two main aspects, these being (i) defining several pre-defined or pre-set independent parts or elements of a commercial product or article, and (ii) providing several design options for each part or element.

Such a system may be provided in either a manual format or an automated format such as a computerized system, and upon a user having completed the selection of design elements, the elements are assembled so as to provide a user-defined article or product, which may result in a visually distinct article in comparison to articles existing on the market which embodies a user's personal aesthetic stylization.

### OBJECT OF THE INVENTION

It is an object of the present invention to provide a process and system for the design of wearable articles and accessories, which overcomes or at least partly ameliorates at least some deficiencies as associated with the prior art.

### SUMMARY OF THE INVENTION

In a first aspect, the present invention provides a process operable using a computerized system for displaying an article from a set of wearable articles or accessories, wherein the article is displayed based upon a correlation between data indicative of features of mental impression of an article and the displayed article, the computerized system including a touch sensitive input device, a processor module and a visual display module operably interconnected together via a communication link, said process including the steps of:

(i) entering via a touch sensitive input device a first visual representation indicative of at least a portion of a mental impression of an article, wherein the first visual representation is a two-dimensional representation in a first predetermined viewing plane, wherein the first visual representation is displayed in real time on a visual display module;

(ii) in a processor module, comparing during step (i) data derived from input of the first visual representation and a plurality of data sets each of which corresponds to and is derived from each article of a plurality of articles, wherein data sets are each derived as a two-dimensional data in said first predetermined viewing plane; and

(iii) displaying on the visual display module, responsive to a predetermined threshold of correlation between the data derived from input of the first visual representation and at least one of the plurality of data sets from step (ii), a visual representation of at least a first article corresponding to the at least one of the plurality of data sets.

Preferably, the first visual representation is input by a user as a line drawing, the plurality of data sets are outlined projections of the plurality of articles in the first predetermined viewing plane.

The correlation between the data derived from input of the first visual representation and at least one of the plurality of data sets is preferably determined based upon a first best fit criteria.

Preferably, a second article corresponding to another of the least one of the plurality of data sets is displayed on the visual display module, and wherein the second article is displayed as a second best fit criteria with respect to the first best fit criteria.

The process preferably further includes the step of entering via the touch sensitive input device a second visual representation indicative of at least a portion of a mental impression of the article, wherein the second visual representation is a two-dimensional representation in a second predetermined viewing plane; wherein in the processor module, data derived from input of the second visual representation and a plurality of data sets each of which corresponds to and is derived from each article of a plurality of articles and wherein data sets are each derived as a two-dimensional data in said second predetermined viewing plane are compared; and wherein on a visual display module, responsive to a predetermined threshold of correlation between the data derived from input of the first visual representation and the data derived from input of the second visual representation and at least one of the plurality of data sets, the visual representation of the least a further article corresponding to the at least one of the plurality of data sets is displayed.

Preferably, the step further entering via the touch sensitive input device a second visual representation indicative of at least a portion of a mental impression of the article is performed after step (iii) of the first aspect.

Upon display on the visual display module an article corresponding to the at least one of the plurality of data sets considered by a user to sufficiently represent the mental impression of an article, the user may select such an article via touch sensitive input device as a purchase item.

Preferably a weighting factor is applied to attributes of the article, such that the comparison between data derived from input of at least the first visual representation and the plurality of data sets when determining if the predetermined threshold has been met includes said weighting factor.

The wearable article or accessory may be an article of jewelry, clothing, footwear, headgear or handbags.

In a second aspect, the present invention provides a computerized system for displaying an article from a set of wearable articles or accessories, wherein the article is displayed based upon a correlation between data indicative of features of mental impression of an article and the displayed article, the computerized system including:

a touch sensitive user input device for receiving a first visual representation indicative of at least a portion of a mental impression of an article, wherein the first visual representation is a two-dimensional representation in a first predetermined viewing plane;

a processor module in communication with the touch sensitive user input device, for comparing data derived from input of the first visual representation with a plurality of data sets each of which corresponds to and is derived from each article of a plurality of articles, wherein data sets are each derived as a two-dimensional data in said first predetermined viewing plane; and

a visual display module in communication with the processor module, for providing a visual representation of at least a first article corresponding to the at least one of the plurality of data sets, responsive to a predetermined threshold of correlation between the data derived from input of the first visual representation and at least one of the plurality of data sets.

Preferably, the touch sensitive user input device is integrally provided with the visual display module.

The processor module may include a data store, said data store including said plurality of data sets for the plurality of articles.

Preferably, at least the touch sensitive user input and the visual display module are adapted for deployment in a point of sale environment.

The processor module may be located at a location remote to the touch sensitive user input device and the visual display module, and is in communication with the touch sensitive user input device and the visual display module by way of a telecommunications network.

The wearable article or accessory may be an article of jewelry, clothing, footwear, headgear and handbags.

In a third aspect, the present invention provides a process operable using a computerized system for designing and displaying wearable article or accessory, wherein the wearable article or accessory is displayed based upon a correlation between data indicative of features of mental impression of a wearable article or accessory and attributes of wearable articles or accessories, the computerized system including a touch sensitive input device, a processor module and a visual display module operably interconnected together via a communication link, said process including the steps of:

(i) entering via a touch sensitive input device a first visual representation indicative of at least a portion of a mental impression of an article, wherein the first visual representation is a two-dimensional representation in a first predetermined viewing plane;

(ii) in a processor module, comparing during step (i) data derived from input of the first visual representation and a plurality of data sets each of which corresponds to and is derived from attributes of wearable articles or accessories, wherein data sets are each derived as a two-dimensional data in said first predetermined viewing plane; and

(iii) displaying on a visual display module, responsive to a predetermined threshold of correlation between the data derived from input of the first visual representation and at least one of the plurality of data sets from step (ii), a visual representation of at least a first article comprised of attributes wearable articles or accessories corresponding to the at least one of the plurality of data sets.

The wearable article or accessory may be an article of jewelry, clothing, footwear, headgear and handbags

In a fourth aspect, the present invention provides a computerized system for designing and displaying a wearable article or accessory, wherein the wearable article or accessory is displayed based upon a correlation between data indicative of features of mental impression of a wearable article or accessory and attributes of wearable articles or accessories, the computerized system including:

a touch sensitive user input device for receiving a first visual representation indicative of at least a portion of a mental impression of a wearable article or accessory, wherein the first visual representation is a two-dimensional representation in a first predetermined viewing plane;

a processor module in communication with the touch sensitive user input device, for comparing data derived from input of the first visual representation with a plurality of data sets each of which corresponds to and is derived from attributes of wearable articles or accessories, wherein data sets are each derived as a two-dimensional data in said first predetermined viewing plane; and

a visual display module in communication with the processor module, for providing a visual representation of at least a first wearable article or accessory corresponding to the at least one of the plurality of data sets, responsive to a predetermined threshold of correlation between the data derived from input of the first visual representation and at least one of the plurality of data sets.
The wearable article or accessory may be an article of jewelry, clothing, footwear, headgear and handbags.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

FIG. 1a depicts a schematic represent of a first embodiment of a system according to the present invention;

FIG. 1b depicts a schematic represent of a second embodiment of a system according to the present invention;

FIG. 2a depicts a schematic represent of a third embodiment of a system according to the present invention;

FIG. 2b depicts a schematic represent of a fourth embodiment of a system according to the present invention;

FIG. 2c depicts a schematic represent of a fifth embodiment of a system according to the present invention;

FIG. 3 shows a flow chart of the process according to the present invention;

FIGS. 4a-4r provide a first illustrative example of the use of an embodiment of a system according to the present invention;

FIGS. 5a-5f provide a second illustrative example of the use of an embodiment of a system according to the present invention;

FIG. 6a provides a third illustrative example of the use of an embodiment of a system according to the present invention;

FIGS. 6b and 6c provide a fourth illustrative example of the use of an embodiment of a system according to the present invention;

FIG. 6d provides a fifth illustrative example of the use of an embodiment of a system according to the present invention;

FIGS. 6e and 6f provide a sixth illustrative example of the use of an embodiment of a system according to the present invention;

FIGS. 7a-7d provide a seventh illustrative example of the use of an embodiment of a system according to the present invention;

FIGS. 8a-8c provide an eighth illustrative example of the use of an embodiment of a system according to the present invention;

FIGS. 9a-9c provide a ninth illustrative example of the use of an embodiment of a system according to the present invention;

FIGS. 10a-10c provide a tenth illustrative example of the use of an embodiment of a system according to the present invention;

FIGS. 11a-11d provide an eleventh illustrative example of the use of an embodiment of a system according to the present invention; and

FIGS. 12a and 12b provide a twelfth illustrative example of the use of an embodiment of a system according to the present invention.

### DETAILED DESCRIPTION OF THE DRAWINGS

The present invention provides a system and process for design of wearable articles and accessories which overcome deficiencies and limitations of systems and processes of the prior art.

The present inventors have identified disadvantages of such systems and processes of the prior art which include that as such systems and processes provide a list or visual representation of design elements of different parts or elements are presented to a user, it has been determined that a user is confronted with a large number of variations or options of various design elements throughout the process of designing an article, which provides distraction and causes creative design inhibition, and also provides a limitation of being effectively a selection and assembly process without necessarily allowing user perception of the interrelationship between the various elements which restricts holistic creativity. As such, articles designed by such processes may require much iteration following assembly of design elements.

Further, the present inventors have identified that in the case where such a design process is provided so a user can effectively select an article from a set of articles using such a process whereby the article is either assembled or manufactured based on the user's input or is pre-existing and ultimately provided following the design element selection, the user may be inadvertently directed ultimately to an article having an overall visual impression which may not necessarily be what the user would have selected given greater design freedom, thus not truly representative of the user's style and design philosophy.

As identified by the present inventors, a user or designer often has a general thought or idea of the manner in which an article is desired to look, which generally is not of a tangible element by element selection, but rather a whole overall impression as to how an article is desired to appear, with the article often existing within the designer or user's “mind's eye” ,and existing systems provide either distraction or invoke design prejudice, and have limit extraction of the designer or user's true design idea.

Accordingly, the present inventors have provided a system and process which enables extraction of a user or designer's design of an article in a holistic manner, such that the system can identify design attributes of the user or designer's design, without providing prejudice or confusion, thus providing a design of an article or directing a user or designer to an existing article or embodiment of an article, which is more truly representative of the design of the user or designer.

Further, the present inventors have identified that in at the field of wearable articles and accessories, the manner in which new designs of articles for disposal on the commercial market may not necessarily result in high consumer uptake, and may prejudice the development and evolution of design of articles, and not fully satisfy consumer perception. As such, consumers often follow the market of what is presented, rather than the market providing articles embodying a design having full market appeal.

The present inventors have noted that often the industry dictates to the market the trends of the market, which ultimately may not have a large market and consumer satisfaction, which is inhibitive of design evolution and development.

Typically, industry dictates trends and styles, however with market research an input to assist industry in determining what designs of articles, such as wearable articles and accessories, will appeal to the market, Market research is often conducted by focus groups, surveying, market experience, by designers and artistic persons working in or engaged by industry, as tools for determining a perception of what design attributes for particular articles and overall visual impression of articles will be well received by consumers and the market.

However, there have been observed countless designs which, although considered likely to achieve market success, have not performed sufficiently regardless. Further, the present inventors have determined that a selection of articles such as wearable articles and accessories, which is either too restrictive or too vast, may not be well received by the market.

As such, from an industry standpoint, predictive market intelligence and perception is paramount from both a trend-setting and a trend-following standpoint, and providing articles such as wearable articles and accessories which are well received by consumers and the market, provides industry with suitable information for manufacture, supply, warehousing volumes, deliverable times and the like, thus reducing excessive or non-disposable inventory.

Accordingly, the present invention provides at least the following advantages over systems and processes of the prior art in at least the field of wearable articles and accessories:

(i) Design freedom and non-prejudice in the design of new articles by designers from a holistic standpoint,

(ii) Provides ability for consumers to make selection of existing articles without being confused, distracted or prejudiced by being confronted with too much selection,

(iii) Provides ability for consumers to make selection of existing articles without being confused, distracted or prejudiced by viewing such articles prior to the design representation or impression existing within the consumer's mind being extracted, resulting in selection of an article more in keeping with a consumer's desired visual impression,

(iv) Provides industry with a mechanism to predict changes in market consumer perception of design appeal of articles, and thus provides industry with the ability to provide to the market articles having a greater likelihood to satisfy both current and future market sentiment,

(v) Provides industry with a mechanism to both set trends as well as follow market trends, and

(vi) Provides industry with a mechanism to assist in manufacturing, supply chain, warehousing and inventory control, which assists industry as well as assisting in providing market satisfaction.

In order to address deficiencies of the prior art as well as provide the above advantages to designers, consumers and industry, the present inventors have provided a system as follows.

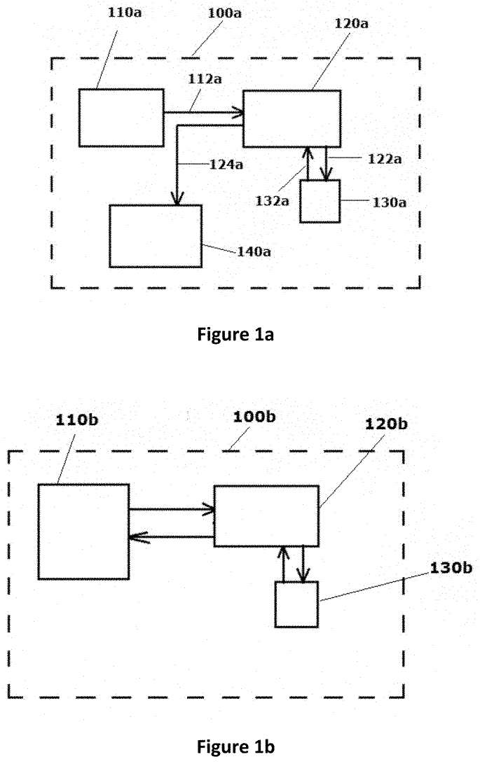

Referring to FIG. 1a, there is shown a schematic represent of a first embodiment of a system 100a according to the present invention. The system 100a includes a touch sensitive input device 110a in communication 112a with a processor module including processor 120a, which is in communication 122a, 132a with a data store 130a. A visual display unit 140a is provided, which is in communication 124a with the processor 120a.

The touch sensitive input device 110a is a touch sensitive sensor, which allows tactile user input, such as a touch screen which may be operable by hand directly or by way of a stylus.

Referring to FIG. 1b, there is depicted a schematic represent of a second embodiment of a system according to the present invention, whereby the touch sensitive input device is integrally provided with the visual display unit as an input and display unit 110b, such as a touch screen device which can receive a user input directly or by way of a hand operable stylus. Similarly as described in reference to FIG. 1a, the present embodiment includes a processor 120b and a data store 130b.

In reference to the embodiments as depicted in FIGS. 1a and 1b, the system 100a, 100b may be provided as a single unit and with the integers of the system 100a, 100b being provided as an integral device. Alternatively, the integers of the system 100a, 100b can be provided separately, and the processor 120a, 120b being provided either in an adjacent location to the touch sensitive input device and visual display unit or provided at a remote location and in communication with the touch sensitive input device and visual display unit by way of a telecommunications network. Further, the data store 130a, 130b may be located adjacent the processor 120a, 120b or located at a remote location and in communication with the processor 120, 120b by way of a telecommunications network.

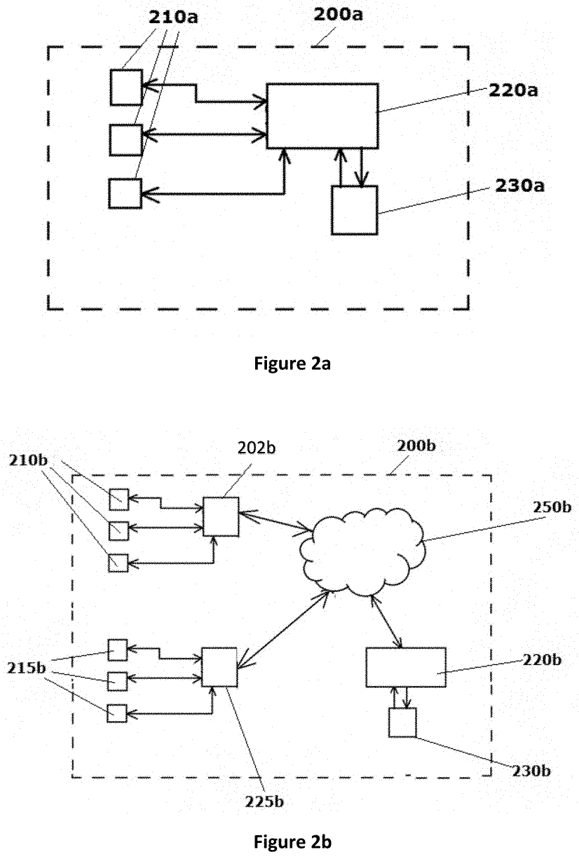

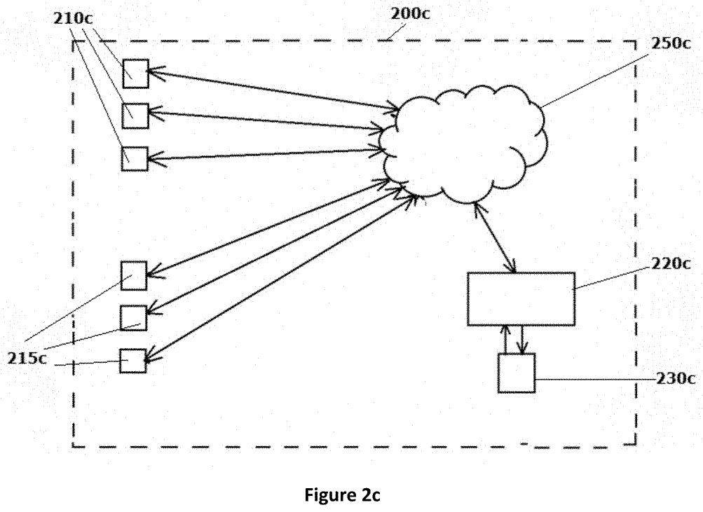

Referring to FIG. 2a, there is depicted a schematic represent of a third embodiment of a system 200a according to the present invention. In the present embodiment, there exists a plurality of the touch sensitive input device and visual display units which are provided in combination as an input and display unit 210a, which may be a touch or tactile sensor in combination with a visual display unit.

In the present embodiment, the plurality of input and display units 210a are in communication with a processor 220a, which is in communication with a data store 230a. The processor 220a and data store 230a may be located adjacent the plurality of input and display units 210a, or at a remote location.

Further, the data store 230a may be located adjacent the processor 220a, or located at a remote location and in communication with the processor 220a by way of a telecommunications network.

As shown in FIG. 2b, there is depicted a schematic represent of a fourth embodiment of a system 200b according to the present invention. In the present embodiment, there is provided a first plurality of input and display units 210b and a second plurality of input and display units 215b. The first plurality of input and display units 210b and a second plurality of input and display units 215b are located at separate locations, with the first plurality of input and display units 210b being in communication with a first local server 202b, and the second plurality of input and display units 215b being in communication with a second local server 225b.

The first local server 202b and the second local server 225b are in communication with a remotely located processor 220b via a telecommunications network 250b such as the internet, with the remotely located processor 220b being in communication with an adjacent data store 230b.

Referring now to FIG. 2c, there is depicted a schematic represent of a fifth embodiment of a system 200c according to the present invention. In the present embodiment, there is provided a first plurality of input and display units 210c and a second plurality of input and display units 215c, which are located at different locations to each other. The first plurality of input and display units 210c and a second plurality of input and display units 215c are in direct communication with a processor 220c via a telecommunications network 250c such as the internet, the processor 220c being in communication with a data store 230, whereby the processor 220c and data store 230 are at a remote location with respect to the first plurality of input and display units 210c and a second plurality of input and display units 215c.

As will be appreciated by those skilled in the art, the arrangements and locations of integers of embodiments of systems according to the present invention as exemplified in FIGS. 1 a, 1 b, 2a, 2b and 2c and exemplary embodiments, and alternate arrangements are also applicable to the invention.

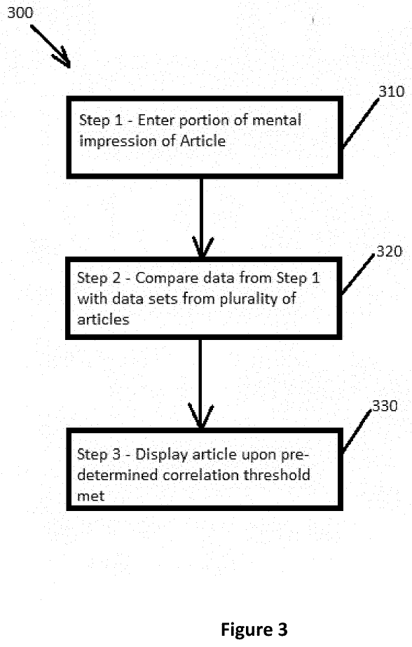

Referring now to FIG. 3, there is shown a flow chart 300 of the process according to the present invention.

The process of the present invention is operable using a computerized system such as those as shown and described in reference to FIGS. 1 a, 1 b, 2a, 2b and 2c.

The process and as implemented in a computerized system, provides for displaying an article from a set of wearable articles or accessories. Such an article or accessory may be an article of jewelry, clothing, footwear, headgear and handbags, for example.

Within the process of the present invention, the article is displayed based upon a correlation between data indicative of features of mental impression of an article and the displayed article.

A computerized system in which the process is embodied, includes a touch sensitive input device, a processor module and a visual display module operably interconnected together via a communication link.

The process including the steps of:

First Step 310 includes entering via a touch sensitive input device of the system a first visual representation indicative of at least a portion of a mental impression of an article. The first visual representation is a two-dimensional representation in a first predetermined viewing plane. For example, when the article is a ring when considered by a user from above, a mental impression of the user would include the stone of the ring as well as the band of the ring.

Second Step 320 in a processor module, comparing during the First Step data derived from input of the first visual representation and a plurality of data sets each of which corresponds to and is derived from each article of a plurality of articles, wherein data sets are each derived as a two-dimensional data in said first predetermined viewing plane. As such, the data sets are derived from articles in the same viewing place as the first visual representation entered by the user.

Third Step 330 displaying on a visual display module of the system, responsive to a predetermined threshold of correlation between the data derived from input of the first visual representation and at least one of the plurality of data sets from the second step, a visual representation of at least a first article corresponding to the at least one of the plurality of data sets.

As will be understood, only upon a certain threshold of correlation will an article be displayed for consideration by a user. As such, when entering or drawing the mental impression, the user is not exposed to or distracted by being provided visual representations of articles.

Accordingly, a user may graphically design or illustrate an article as borne in the user's mind's eye, prior to having a best fit representation of an article displayed and thus, the mental impression may be extracted from the user a best fit representation only provided once a threshold is reached which may be considered a threshold whereby enough information has been extracted from the user such that a sufficient correlation exists so that the user may be displayed an article which has a sufficient shape and geometry so as to be a sufficient match to the user's mental impression of an article.

The first visual representation is input by a user as a line drawing, via the touch sensitive input device, which may be directly by hand or by way of a stylus, giving the user good cognitive effect, as the user input is displayed in real time.

The plurality of data sets are outline projections of the plurality of articles in the first predetermined viewing plane.

The correlation between the data derived from input of the first visual representation and at least one of the plurality of data sets is determined based upon a first best fit criteria.

The process 300 and system may display a second article corresponding to another one of the at least one of the plurality of data is displayed on the visual display module, and wherein the second article is displayed as a second best fit criteria with respect to the first best fit criteria.

The process 300 may include a further step of entering via the touch sensitive input device a second visual representation indicative of at least a portion of a mental impression of the article, wherein the second visual representation is a two-dimensional representation in a second predetermined viewing plane;

In the processor module, data derived from input of the second visual representation and a plurality of data sets each of which corresponds to and is derived from each article of a plurality of articles and wherein data sets are each derived as a two-dimensional data in said second predetermined viewing plane are compared.

On a visual display module, responsive to a predetermined threshold of correlation between the data derived from input of the first visual representation and the data derived from input of the second visual representation and at least one of the plurality of data sets, the visual representation of the least a further article corresponding to the at least one of the plurality of data sets is displayed.

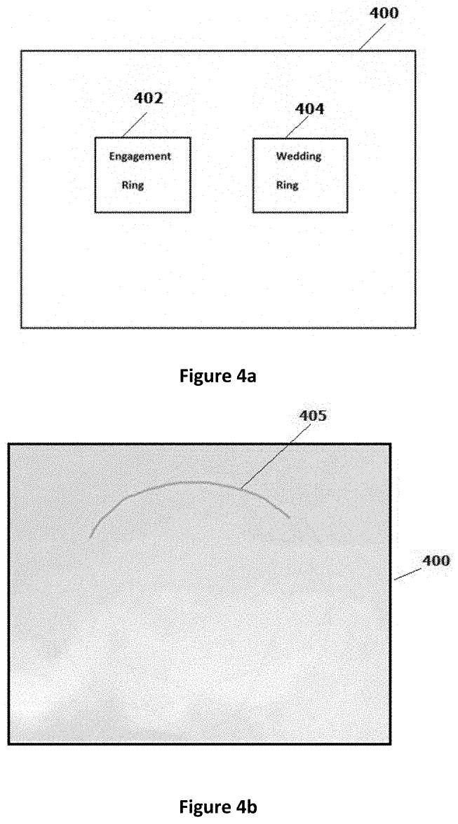

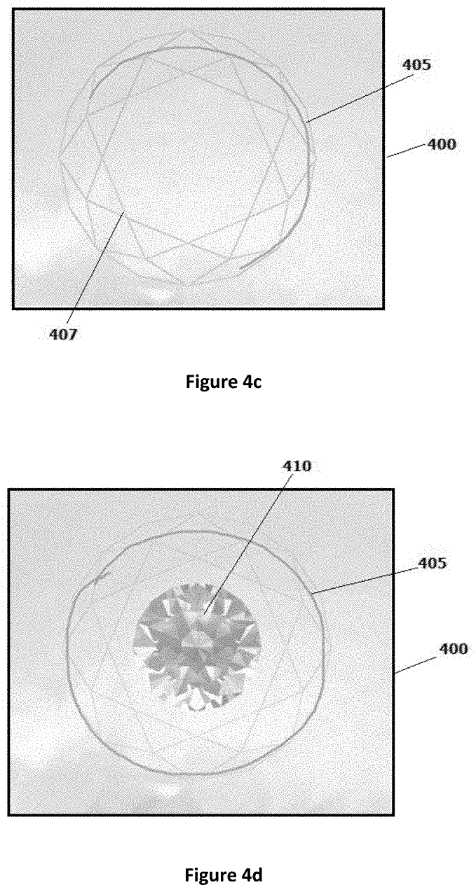

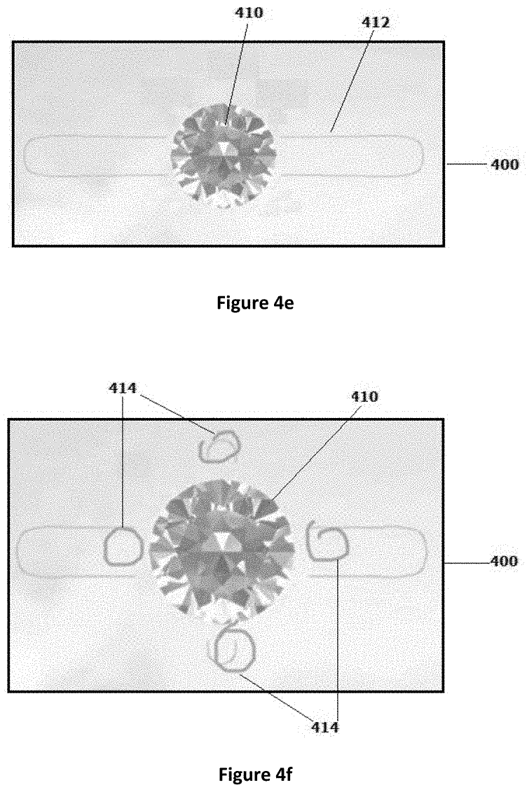

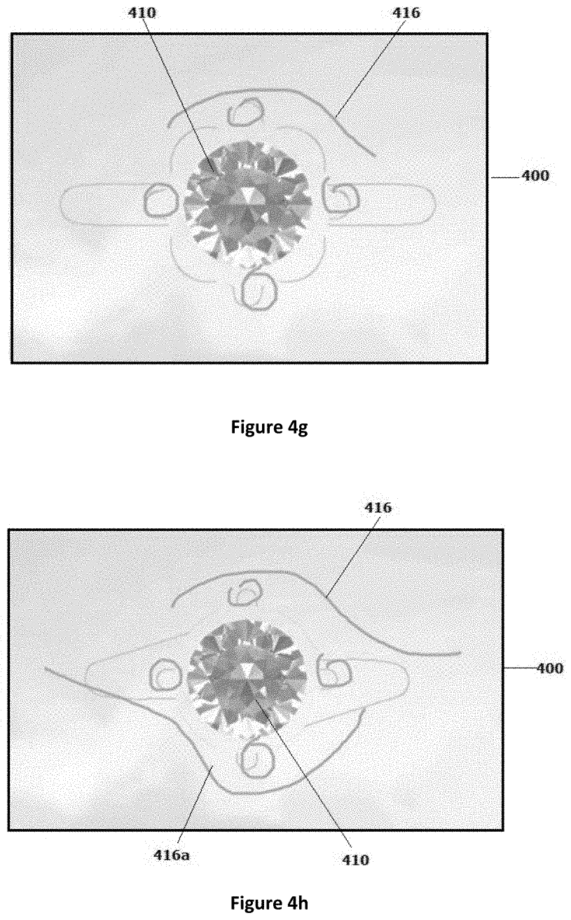

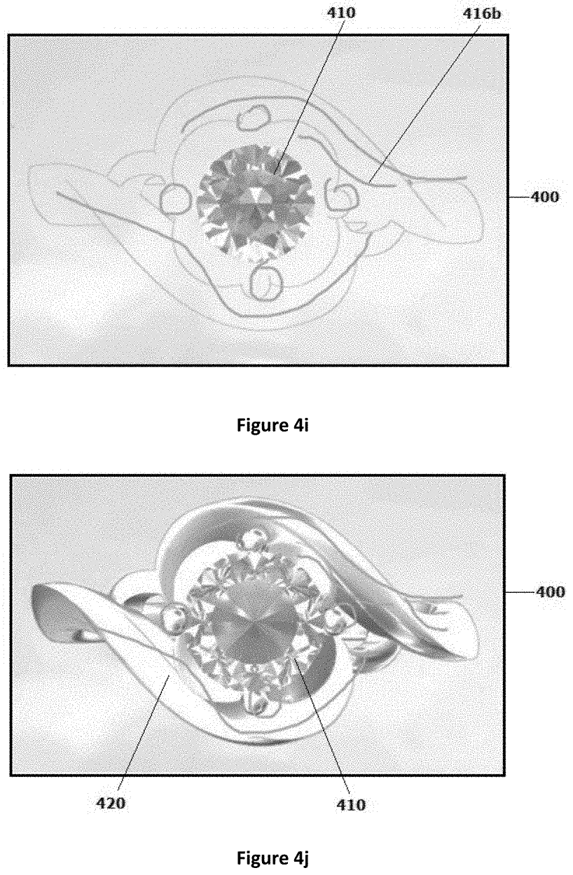

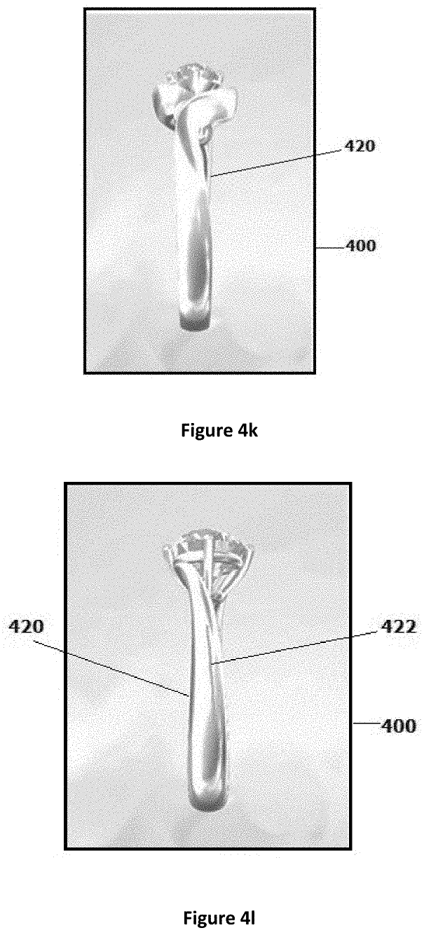

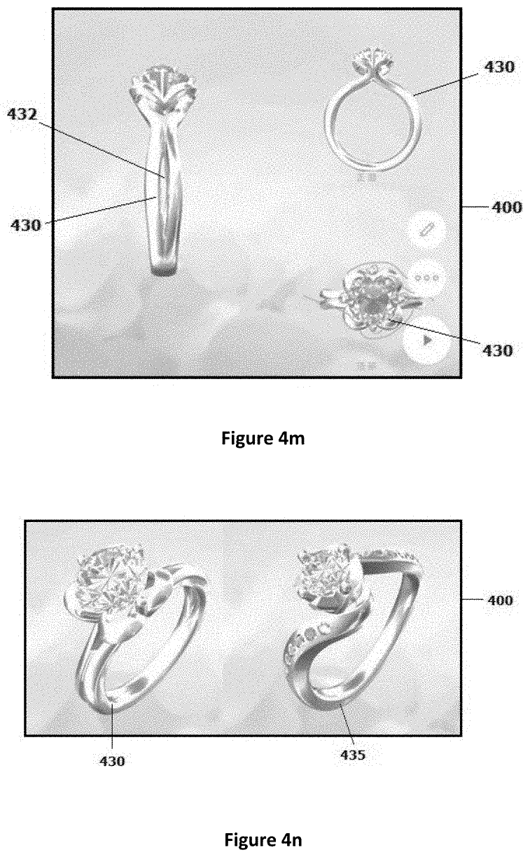

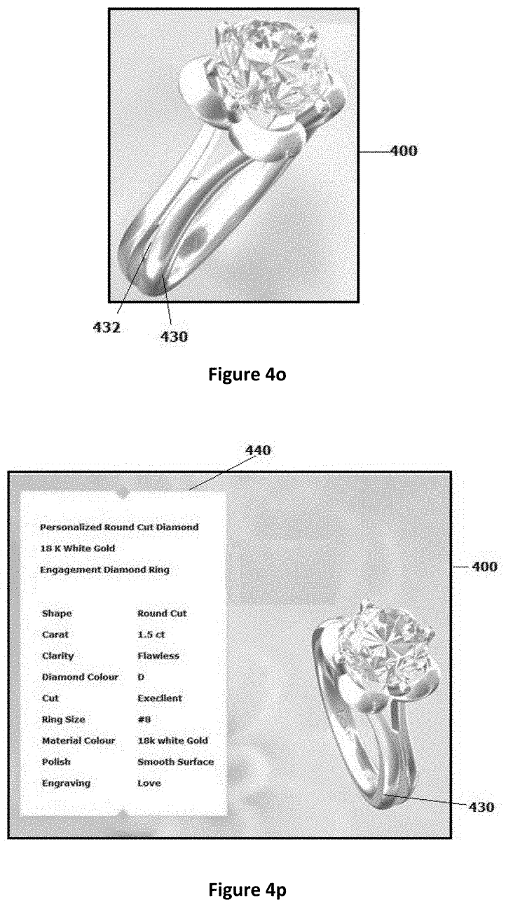

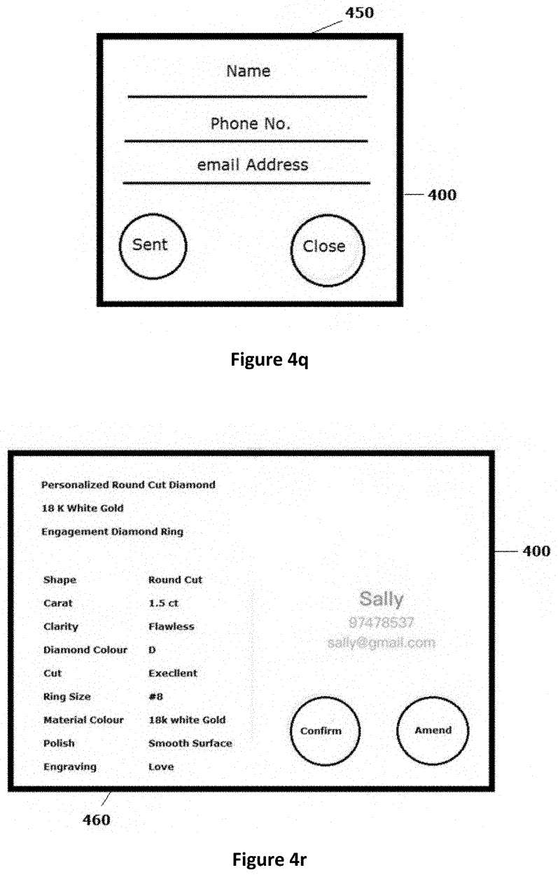

Referring as follows to illustrative examples as depicted in FIGS. 4a to 12b, there are shown and described examples whereby the wearable articles and accessories as exemplified are articles of jewelry, particular rings, using the system and process of the present invention.

However, as will be understood by those skilled in the art, in other applications and embodiments, the present invention is equally applicable to other or alternate wearable articles and accessories, such as garments, apparel, clothing, footwear, headgear, glasses, spectacles, sunglasses, timepieces and other articles of jewelry such as necklaces, bracelets, bangles and the like.

The present invention is particularly applicable to wearable articles and accessories, as such items generally may be considered to have a “fundamental form” and based on personal preference, style, external influence and advertising, users will have an overall general impression in their “mind's eye”, which may be considered as human ability to visualize, or to experience visual mental imagery; in other words, one's ability to “see” things with the mind without production of an image in a tangible form.

Such wearable articles and accessories are generally comprised of design elements, which may be distinctively separate or provided integrally, and the image or impression of such articles is often an overall impression, rather than a precise or analytical representation of individual elements, As such, the image or impression of an article in the mind's eye cannot necessarily be quantifiable, but rather is based upon an individual's overall impression of an article for which various design elements collectively contribute thereto.

Accordingly, extracting an impression or image from one's mind's eye cannot be considered an exacting procedure, and some aspects or elements of article may contribute more to the overall image or impression than of others. Furthermore, some design elements or attributes of an article may be considered to having a greater weighting than others, and some design elements may be considered essential or irreplaceable. Still further, some design elements may be mutually exclusive, and design elements which generally may be considered inapplicable together or incompatible in some cases may be considered of a low weighting from an essentiality standpoint.

As will be understood, even small variations on certain design elements may cause a significant alteration in overall impression and as such, disassembly of an image or impression from the mind's eye into discrete design elements cannot be considered an exacting science.

Assembling an article by selection of individual design elements, such as in systems and processes as provided by the prior art, cannot adequately provide an article from the mind's eye. Such a methodology cannot adequately result in the provision of an article from the mind's eye, for reasons including that individual elements, when viewed individually, cannot be predicted to provide or sufficiently contribute to the overall impression as such intangible input is not evident from such design elements when viewed individually. Thus, the amalgamation of individual design elements in an attempt to provide an initial image or representation of an article held in the mind's eye inevitably will not result in the requisite article.

Accordingly, the present invention provides a process and system which allows for extraction of an image or impression carried by the mind's eye to a representation of the tangible form in a manner which is responsive to a person's input, rather than a person' selection of presented selections of design elements.

Referring to FIGS. 4a-4r, there is provided a first illustrative example of the use of an embodiment of a system according to the present invention, whereby the system includes the features for example of those of FIGS. 1b to 2c, whereby the system includes a touch sensitive input device in conjunction with a visual display unit.

As shown in FIG. 4a, the touch sensitive input device 400 displays options for a user for the design of an engagement ring 402 or a wedding ring 404 and in the present example an engagement ring is selected.

The user is then, as shown in FIG. 4b, requested to draw a two-dimensional view of a design element, in this case the stone of the ring, and commences drawing an arcuate line 405 by hand or by a stylus which is representative of the impression of the stone.

Upon further drawing of the line 405 as shown n FIG. 4c, a construction scaffold 407 may be displayed so as to provide some guidance to the user for the completion of the design element, and as shown in FIG. 4d a round diamond 410 is displayed.

The system correlates the user's design element with a two-dimensional projection of a design element stored in the system, which is a best fit correlation between the user's input and a two-dimensional projection in the corresponding viewing plane from a plurality of engagement rings stored in the system.

At this point in time, whilst a round diamond 410 is a design element from a plurality of engagement rings in the system, the user is not presented with a visual representation of rings which may be selected from, but rather a generalized scaffolding 412 is provided which is representative of the overall general view of a ring in that plane, which includes the band portion of a ring as shown in FIG. 4e.

Now referring to FIG. 4f, a user provides further input of the visual impression of the engagement ring as held in the mind's eye, and draws a series of spaced apart circular features 414 which are parallel and perpendicular to the axis of the band of the ring 412.

Further user input is provided progressively, with arcuate input lines 416 and 416a in the form of a symmetric “S” representation indicative of the geometry or shape of the impression of the engagement ring visualized by the user as shown in FIGS. 4g and 4h, and a further input line 416b as shown in FIG. 4i is input by the user giving as generalized representation of an elongate curved geometry curving about the round diamond 410. It should be noted that during the input by a user of the generalized impression of the ring, whilst a correlation is being conducted of the design input against the data sets held in the system, the user is not displayed potential options of rings prematurely, so as not to prejudice the user as to potential existing designs and be required to make a selection, but rather allows for continued input and capture of the user's input based on the user's overall impression of an engagement ring when viewed in the two-dimensional plane from above.

It should be noted that the user is not inputting element by element of a ring and is not prompted to do so, but rather is required to provide input indicative of the overall visual characterization of the ring, as design elements may collectively provide visual representation of the ring, and could possibly be integrally formed with each other, and collectively provide the impression of the ring. This is distinct from systems of the prior art which essentially provide a user with a menu of individual elements, which a user progressively selects, then provides an assembly of the design elements to display and end product. Such systems of the prior art, by providing discrete element or groups of elements selection, restricts a user's creativity and the display of such discrete design elements in a step-like fashion inhibits the user from design freedom for overall holistic input.

Whilst generalized guidance by way of a scaffold may be provided to the user, this is of a generalized fundamental form and merely provides a user with an orientation about which to provide input and a generalized generic framework, and can be considered to cover or be applicable to all datasets from articles stored in the system, and does not distract or prejudice s user by prematurely displaying existing designs, which would dampen the creative input of the user and change from a design input based on the image or impression held within the user's mind's eye.

As such, the system of the present invention allows for extraction of the user's impression of the ring receives inputs which can be correlated to overall visual representations of rings within the system, as opposed to a design element selection process as in the prior art.

Turning to FIG. 4j, as shown an engagement ring 420 is displayed, which is a “best fit” based on the user's data input in the two-dimensional place from above the ring and that of a data set projected in the same two-dimensional plane from rings held in the system. Upon sufficient correlation being obtained by the processor of the system based on preexisting data held by the data store, the user is display the engagement ring 420 which is the best fit between the data set as input and data sets held within the system.

As will be seen, the ring 420 as displayed in FIG. 4j includes the stone 410, which may be considered for engagement rings a key element as it contributes substantially to the overall visual impression, as well as four-prong mounting arrangement which is integral with the ring band which separates into an “S” shaped potion which may be considered akin to a bezel type arrangement.

Importantly and to be noted, in the present ring, there is not a traditional claw arrangement or a traditional bezel arrangement and as such, the portion of the ring which secures the stone 410 is not a discrete element per se, but an integral functional portion with a unique visual impression.

Within the present example, whilst a main design element, the stone is initially extracted from the user, this is not an element selection process but rather permits the user to input generalized geometry of the stone before any representations of types of stones are displayed to the user, so as not to inhibit design creativity. Within engagement rings, the stone is a key or heavily weighted design element and as such, in such an example the diamond is displayed prior to display of the whole ring 420 being displayed.

Importantly, throughout the input process, which may be considered an extraction process of the user's own visual impression, whilst the system is correlating input data with data sets from existing articles in the data store, the mounting portion of the stone 410 is not displayed, so as to avoid a user being prematurely directed to select aspects of the ring 420 which may result in preventing full expression and extraction of the user's visual impression of the ring, but rather displays a ring only once sufficient data has been received such that one or more “best fit” rings can be displayed. Premature display of design elements or features stifle the design or extraction process, and is prejudicial to the user's creative input based on the user's visual impression.

Once a sufficiently correlating ring 420 can be displayed in a first viewing place, the system can display the ring 420 in other viewing planes such as is shown in FIG. 4k. Further impression extraction may be provided to the user, and as shown in FIG. 4l the user has input a vertical line 422 along the vertical axis of the band of the ring 420, indicative of the user visualizing a design feature along the band.

Responsive to such user input as provided at FIG. 4l, sufficient correlation of the applicable data set as input with a data set from the data store is achieved, and as shown in FIG. 4m a different ring 430 with a dual band defined by a slot 432 is displayed for the user's consideration, with all three orthogonal views displayed.

As will be noted, the ring 430 does not include the same setting arrangement of the diamond 410 of ring 420 yet there is a degree of correlation with earlier design input such as a four-prong claw arrangement with the prongs moved 45 degrees about the axis of the band and also including a laterally protruding bezel type portion with a degree of curvature.

As is shown in FIG. 4n, a user is displayed other rings whose datasets have a requisite degree of correlation with the user input data set with predetermined weighting in relation to design elements or features being provided, and alternate designs of rings 430 and 435 being displayed for the user's consideration.

Again as will be noted, the user is not prematurely displayed other similar or correlating articles until sufficient user input is received, after which display is considered not prejudicial or stifling to the impression extraction or design process.

A user may then consider the other similar and correlating articles, and may in embodiments of the invention examine alternate designs by way or rotation or zoom such as in FIG. 4o.

A user may make a selection from a menu, so as to enquire about the attributes and data in relation to the rings displayed, such as is shown in FIG. 4p whereby the information and data pertaining to ring 430 is displayed.

The user may then, via another menu, enter personal data 450 as shown in FIG. 4q which may be used for retention of the rings arrived at during the design process, or for ordering purposes 460 as shown in FIG. 4r whereby a user can confirm or amend a selected ring for purchase.

In embodiments of the invention, a sizing process for a user's finger size may be incorporated, for ordering purposes, whereby user's personal physical data is input and correlated.

Further, in embodiments of the invention, the user may have the option of selecting parameters of the ring, such as white gold, yellow gold, silver of the like, and the carat of the diamond, for user customization.

Also, in other embodiments, there may be provided options for alteration of ring parameters, such as the width of the band.

In other embodiments, a user's design could be custom or bespoke manufactured, for example by way of 3D printing type technology.

Accordingly, the present invention, through the above visual impression process, can provide for both customized design as well as assisting in directing a user to articles from a plethora of articles which best match the visual impression of a requisite article for the user, whilst avoiding prejudice or restricting creative design and without bamboozling, confusing a user by having to consider numerous different articles in order to make a selection.

Accordingly, the present invention, by providing a process as herein described, obviates the short comings of the prior art, and allows for a user to select and article, in this example an engagement ring, which satisfies the user's requirements.

In addition to assisting the user, the manufacturer or supplier of articles to which the invention is applied, can gain data as to what types of designs are popular, which is beneficial from a manufacturing standpoint.

Also, rather than conduct laborious market research for new designs, the present system can capture data for market research purposes, to gain an indication of aspects of designs which are considered most favorably by the market. This benefits both users and manufactures such that articles can be provided which the market desires, for numerous reasons including those as recited above.

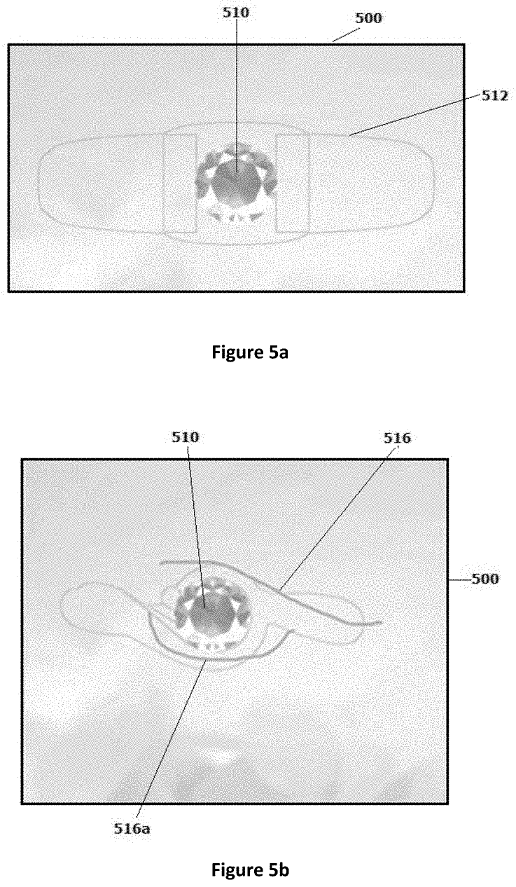

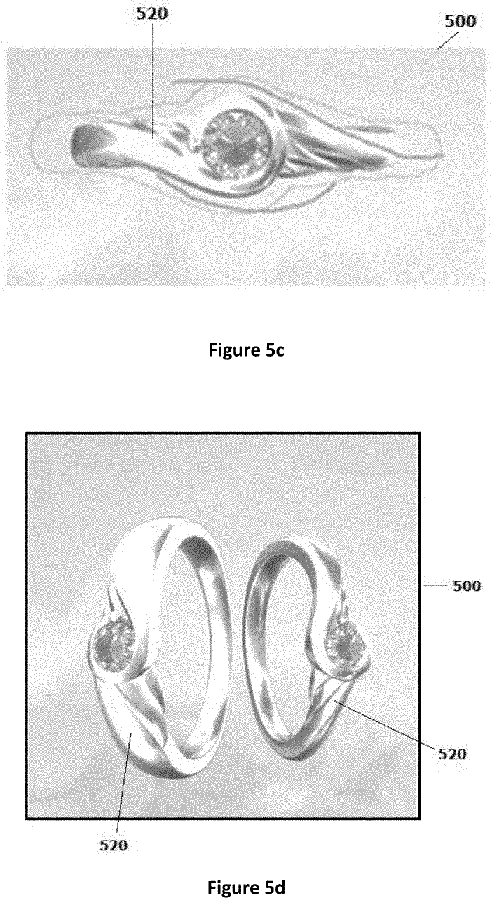

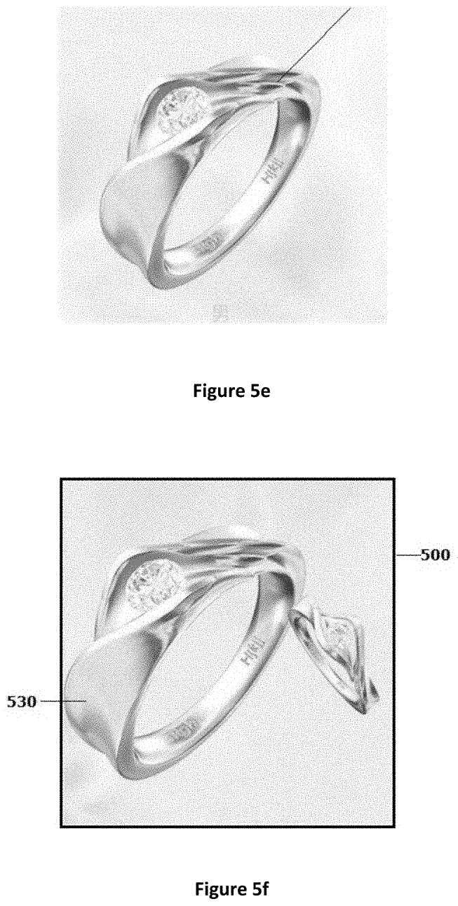

Referring to FIGS. 5a-5f, there is provided a second illustrative example of the use of an embodiment of a system according to the present invention for a wedding band or wedding ring. The user impression extraction process as depicted progressively through FIGS. 5a to 5c is similar as described above with reference to FIGS. 4b to 4l. A diamond 510 and a band 512 are selected by a user via the touch sensitive input device 500 as shown in FIG. 5a. Responsive to the arcuate input lines 516 and 516a in FIG. 5b and partially shown in FIG. 5c, a “best fit” ring 520 displayed in FIG. 5d.

Alternate rings 530 are suggested to the user as shown in FIGS. 5e and 5f, having sufficient correlation between user input data sets.

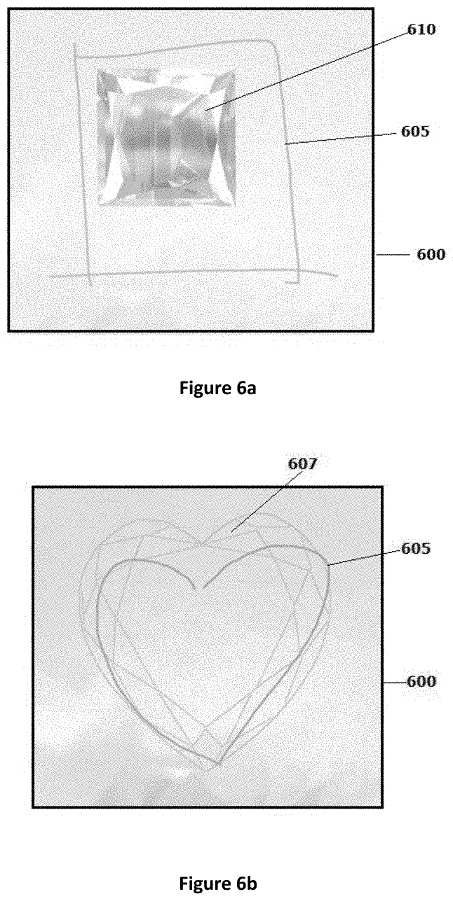

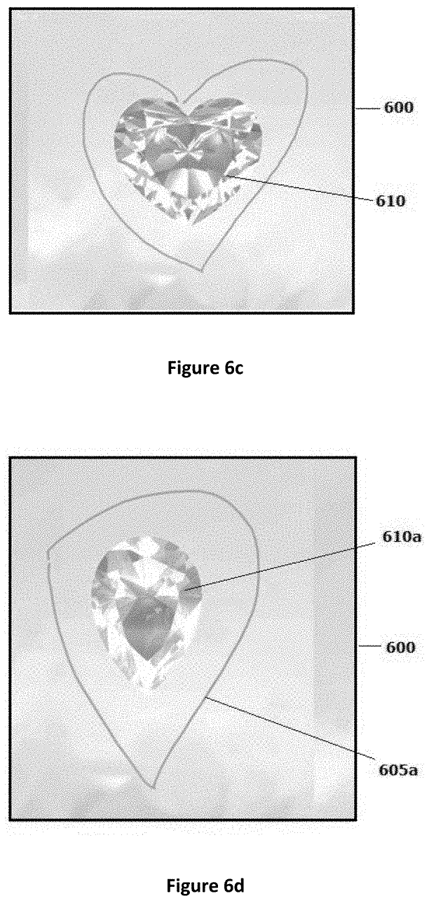

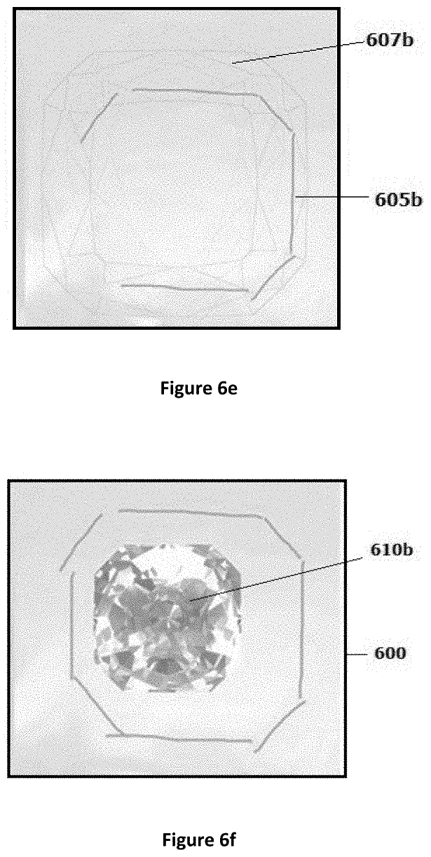

FIG. 6a provides a third illustrative example of the use of an embodiment of a system according to the present invention, using the above user impression extraction process, for a princess cut diamond 610 for a ring.

Another example is shown in FIGS. 6b and 6c provide a fourth illustrative example of the use of an embodiment of a system according to the present invention, using the above user impression extraction process, for a heart shaped cut diamond 610 for a ring upon drawing of input line 605 by a user via a touch sensitive input device 600 and a construction scaffold 607 is provided for suggestion or guidance.

FIG. 6d provides a fifth illustrative example of the use of an embodiment of a system according to the present invention, using the above user impression extraction process, for tear drop shaped cut diamond 610a for a ring upon drawing of input line 605a by a user.

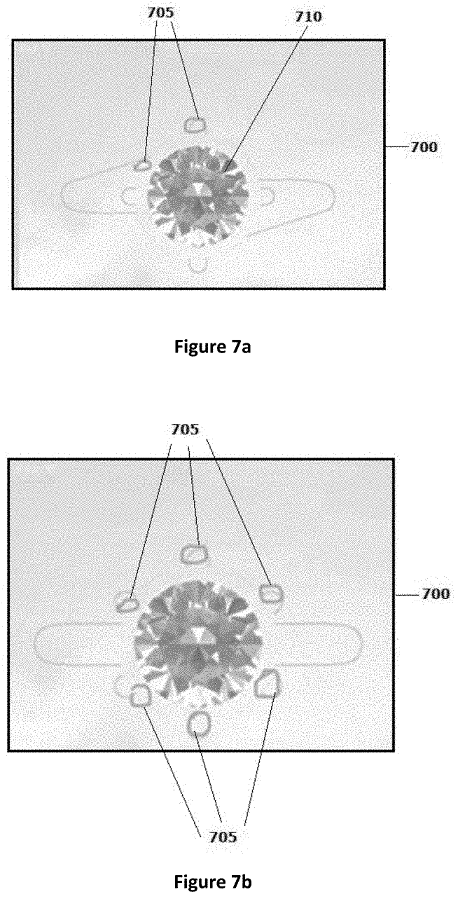

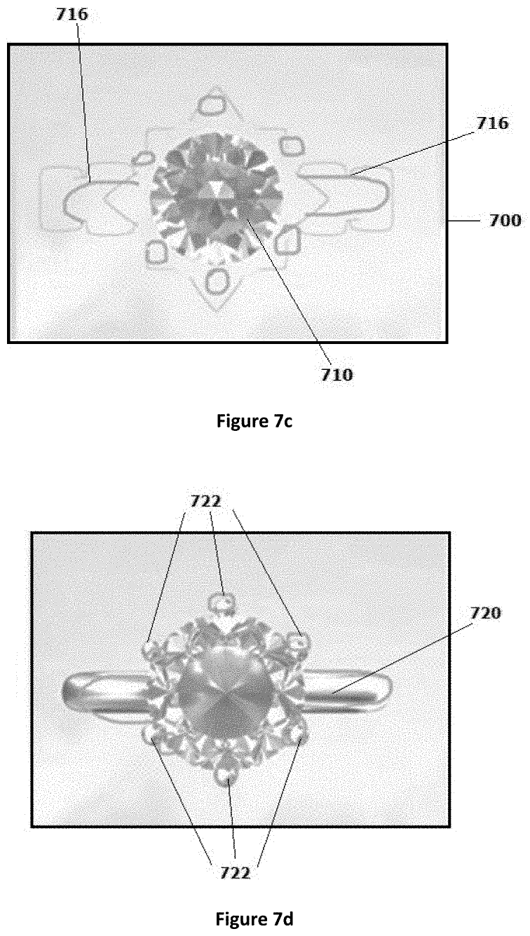

FIGS. 6e and 6f provide a sixth illustrative example of the use of an embodiment of a system according to the present invention, using the above user impression extraction process, for an emerald cut diamond 610b for a ring upon drawing of input line 605b by a user and a construction scaffold 607b is provided for suggestion or guidance. As shown in FIGS. 7a-7d, there is provided a seventh illustrative example of the use of an embodiment of a system according to the present invention, for an engagement ring. As is shown in FIGS. 7a and 7b, a user draws six circles 705 about the selected stone as displayed in a touch sensitive input device 700, in this case a round cut diamond 710. A user subsequently draws the visual impression of the ring as shown in FIG. 7c, with lines 716. Upon a suitable data correlation having been met, a ring 720 is displayed for consideration by a use, having a claw formed from 6 prongs 722.

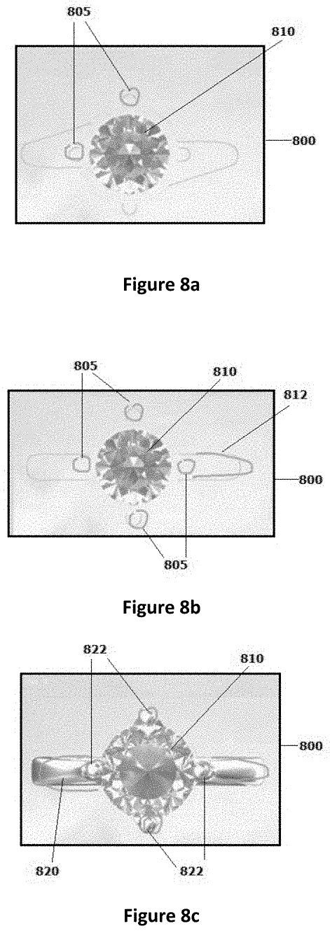

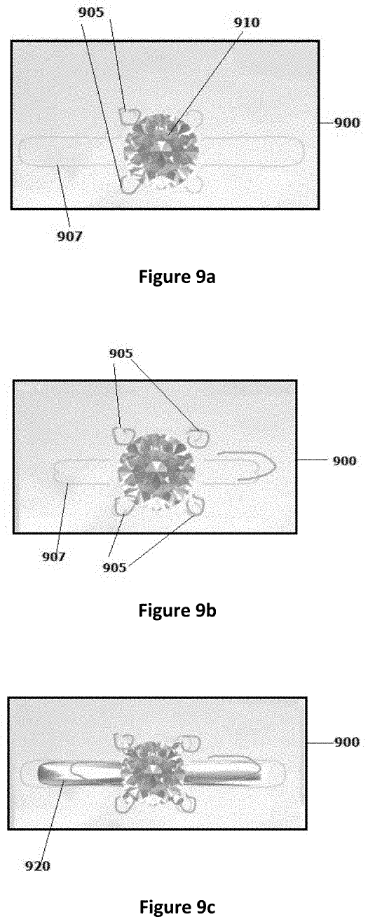

Referring to FIGS. 8a-8c, there is provided an eighth illustrative example of the use of an embodiment of a system according to the present invention, using the process as described with reference to FIGS. 4a to 4r. A user, having selected a round diamond 810 via a touch sensitive input device 800, inputs 4 circles 805 which are parallel and perpendicular to the axis of the band of the ring which is shown as a scaffold in FIG. 8b. The user further inputs line 812 which extends in the direction of a band for the ring. As shown in FIG. 8c, a “best fit” ring 820 is displayed for the user's consideration, with a claw comprised of four prongs 822 corresponding to the location of circles 805. Referring to FIGS. 9a-9c, there is provided a ninth illustrative example of the use of an embodiment of a system according to the present invention. The present example is similar to that of FIGS. 8a to 8c, however the circles 905 are drawing offset by 45 degrees with respect to the axis of the band 907 of the ring via the touch sensitive input device 900. A ring 920 with the diamond 910 selected by a user is displayed for consideration by the user, whereby four prongs corresponding to the circles 905.

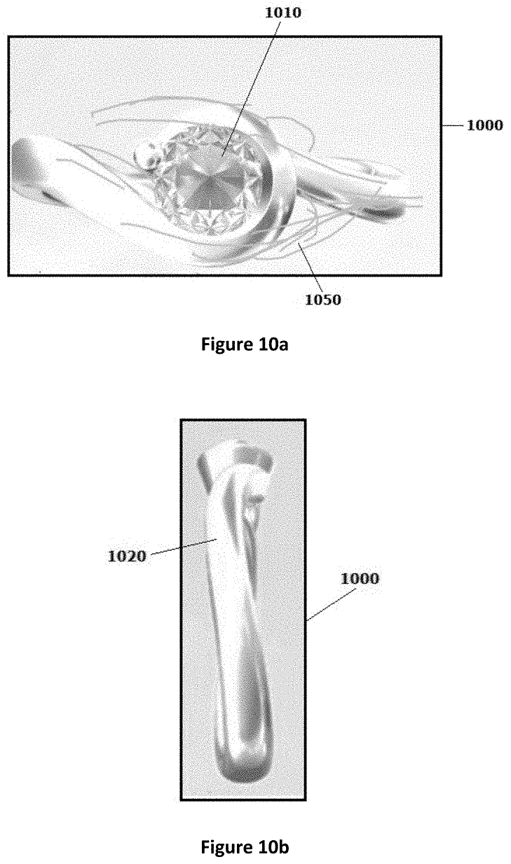

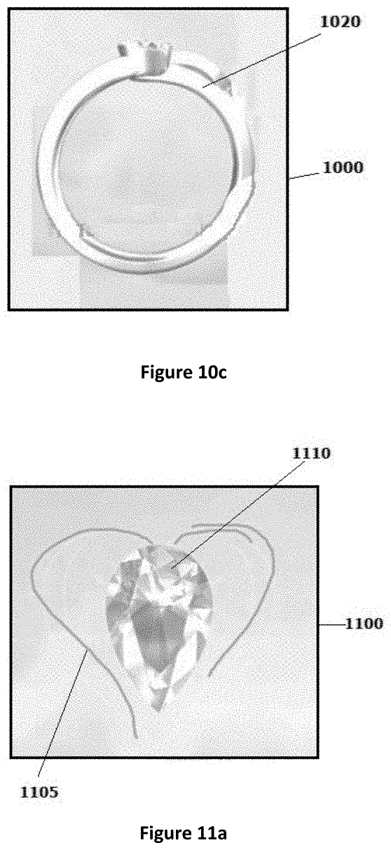

Referring to FIGS. 10a-10c, there is provided a tenth illustrative example of the use of an embodiment of a system according to the present invention. A round diamond 1010 is selected by a user, and construction lines 1050 input by user via a touch sensitive input device 1000, and a “best fit” ring 1020 is displayed for consideration by a user.

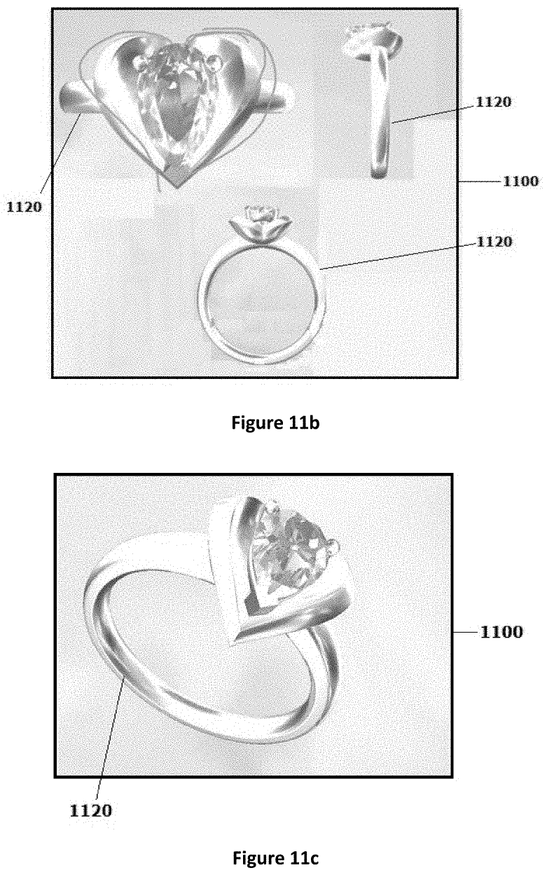

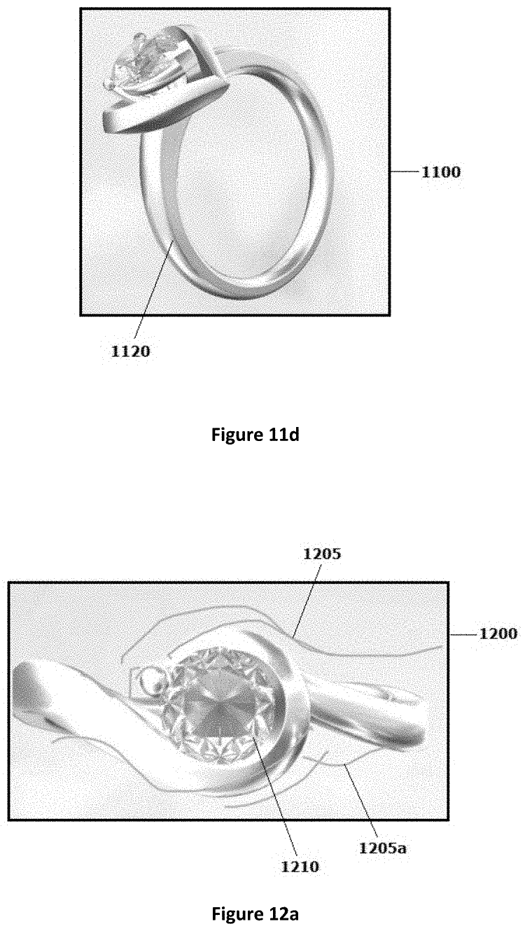

Referring to FIGS. 11a-11d, there is provided an eleventh illustrative example of the use of an embodiment of a system according to the present invention. A tear drop shaped diamond 1110 is selected by a user and heart shaped lines 1105 input by the user via the touch sensitive input device 1100. A “best fit” ring 1120 is displayed for consideration by the user, and side views, front views and two perspective views are provided.

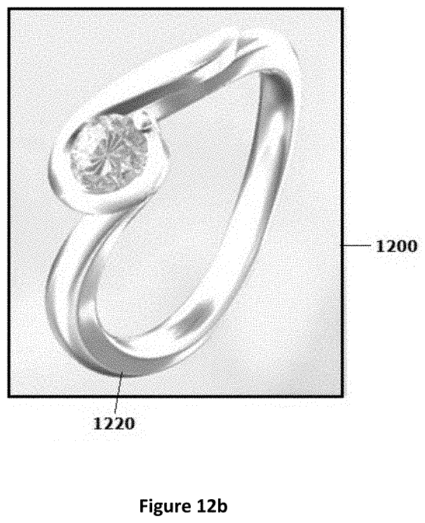

Referring to FIGS. 12a and 12b, there is provided a twelfth illustrative example of the reuse of an embodiment of a system according to the present invention. A round diamond 1210 is selected by the user via the touch sensitive input device 1200, and lines 1205 and 1205a inputted by the user. Upon the suitable correlation being met, ring 1220 is displayed for consideration by the user.

The above 12 examples are applicable for the jewelry industry, for example when the system of the present invention is implemented such that a touch sensitive input device for user input and display is provided in a jewelry store.

Alternatively, the touch sensitive input device may be user-provided, and the visual impression extraction process may be performed at a remote location, such as at the user's home for example.

The processor and data store of such a system may be located at a store or at a remote location. As will be readily understood by those skilled in the art, irrespective of where the processor or data store are located, the implementation of a system embodying the process of the present invention as described, falls within the scope of the invention.

Again, although the examples as above are with reference to the jewelry industry, in other applications and embodiments, the present invention is equally applicable to other or alternate wearable articles and accessories, such as garments, apparel, clothing, footwear, headgear, glasses, spectacles, sunglasses, timepieces and other articles of jewelry such as necklaces, bracelets, bangles and the like.

What is claimed:

1. A process operable using a computerized system for displaying an article from a set of wearable articles or accessories, wherein the article is displayed based upon a correlation between data indicative of features of mental impression of an article and the displayed article, the computerized system including a touch sensitive input device, a processor module and a visual display module operably interconnected together via a communication link, said process including the steps of:
(i) entering via a touch sensitive input device a first visual representation indicative of at least a portion of a mental impression of an article, wherein the first visual representation is a two-dimensional representation in a first predetermined viewing plane, wherein the first visual representation is displayed in real time on a visual display module;
(ii) in a processor module, comparing during step (i) data derived from input of the first visual representation and a plurality of data sets each of which corresponds to and is derived from each article of a plurality of articles, wherein data sets are each derived as a two-dimensional data in said first predetermined viewing plane; and
(iii) displaying on the visual display module, responsive to a predetermined threshold of correlation between the data derived from input of the first visual representation and at least one of the plurality of data sets from step (ii), a visual representation of at least a first article corresponding to the at least one of the plurality of data sets.

2. A process according to claim 1, wherein the first visual representation is input by a user as a line drawing, the plurality of data sets are outline projections of the plurality of articles in the first predetermined viewing plane.

3. A process according to claim 2, wherein and the correlation between the data derived from input of the first visual representation and at least one of the plurality of data sets is determined based upon a first best fit criteria.

4. A process according to claim 1, wherein a second article corresponding to another of the least one of the plurality of data sets is displayed on the visual display module, and wherein the second article is displayed as a second best fit criteria with respect to the first best fit criteria.

5. A process according to claim 1, further including the step of entering via the touch sensitive input device a second visual representation indicative of at least a portion of a mental impression of the article, wherein the second visual representation is a two-dimensional representation in a second predetermined viewing plane;
wherein in the processor module, data derived from input of the second visual representation and a plurality of data sets each of which corresponds to and is derived from each article of a plurality of articles and wherein data sets are each derived as a two-dimensional data in said second predetermined viewing plane are compared; and
wherein on a visual display module, responsive to a predetermined threshold of correlation between the data derived from input of the first visual representation and the data derived from input of the second visual representation and at least one of the plurality of data sets, the visual representation of the least a further article corresponding to the at least one of the plurality of data sets is displayed.

6. A process according to claim 5, wherein the step further entering via the touch sensitive input device a second visual representation indicative of at least a portion of a mental impression of the article is performed after step (iii) of claim 1.

7. A process according to claim 1, wherein upon display on the visual display module an article corresponding to the at least one of the plurality of data sets considered by a user to sufficiently represent the mental impression of an article, the user may select such an article via touch sensitive input device as a purchase item.

8. A process according to claim 1, wherein a weighting factor is applied to attributes of the article, such that the comparison between data derived from input of at least the first visual representation and the plurality of data sets when determining if the predetermined threshold has been met includes said weighting factor.

9. A process according to claim 1, where in the wearable article or accessory may be an article of jewelry, clothing, footwear, headgear or handbags.

10. A computerized system for displaying an article from a set of wearable articles or accessories, wherein the article is displayed based upon a correlation between data indicative of features of mental impression of an article and the displayed article, the computerized system including:
a touch sensitive user input device for receiving a first visual representation indicative of at least a portion of a mental impression of an article, wherein the first visual representation is a two-dimensional representation in a first predetermined viewing plane;
a processor module in communication with the touch sensitive user input device, for comparing data derived from input of the first visual representation with a plurality of data sets each of which corresponds to and is derived from each article of a plurality of articles, wherein data sets are each derived as a two-dimensional data in said first predetermined viewing plane; and
a visual display module in communication with the processor module, for displaying first visual representation in real time and for providing a visual representation of at least a first article corresponding to the at least one of the plurality of data sets, responsive to a predetermined threshold of correlation between the data derived from input of the first visual representation and at least one of the plurality of data sets.

11. A computerized system according to claim 10, wherein the touch sensitive user input device is integrally provided with the visual display module.

12. A computerized system according to claim 10, wherein the processor module includes a data store, said data store including said plurality of data sets for the plurality of articles.

13. A computerized system according to claim 10, wherein at least the touch sensitive user input and the visual display module are adapted for deployment in a point of sale environment.

14. A computerized system according to claim 10, wherein the processor module is located at a location remote to the touch sensitive user input device and the visual display module, and is in communication with the touch sensitive user input device and the visual display module by way of a telecommunications network.

15. A process according to claim 1, wherein the wearable article or accessory is an article of jewelry.

16. A process according to claim 1, wherein the wearable article or accessory selected from the group including clothing, footwear, headgear and handbags.

17. A system according to claim 10, wherein the wearable article or accessory is an article of jewelry.

18. A system according to claim 10, wherein the wearable article or accessory selected from the group including clothing, footwear, headgear and handbags.

19. A process operable using a computerized system for designing and displaying wearable article or accessory, wherein the wearable article or accessory is displayed based upon a correlation between data indicative of features of mental impression of a wearable article or accessory and attributes of wearable articles or accessories, the computerized system including a touch sensitive input device, a processor module and a visual display module operably interconnected together via a communication link, said process including the steps of:
(i) entering via a touch sensitive input device a first visual representation indicative of at least a portion of a mental impression of an article, wherein the first visual representation is a two-dimensional representation in a first predetermined viewing plane, wherein the first visual representation is displayed in real time on a visual display module;
(ii) in a processor module, comparing during step (i) data derived from input of the first visual representation and a plurality of data sets each of which corresponds to and is derived from attributes of wearable articles or accessories, wherein data sets are each derived as a two-dimensional data in said first predetermined viewing plane; and
(iii) displaying on the visual display module, responsive to a predetermined threshold of correlation between the data derived from input of the first visual representation and at least one of the plurality of data sets from step (ii), a visual representation of at least a first article comprised of attributes wearable articles or accessories corresponding to the at least one of the plurality of data sets.

20. A computerized system for designing and displaying a wearable article or accessory, wherein the wearable article or accessory is displayed based upon a correlation between data indicative of features of mental impression of a wearable article or accessory and attributes of wearable articles or accessories, the computerized system including:
a touch sensitive user input device for receiving a first visual representation indicative of at least a portion of a mental impression of a wearable article or accessory, wherein the first visual representation is a two-dimensional representation in a first predetermined viewing plane;
a processor module in communication with the touch sensitive user input device, for comparing data derived from input of the first visual representation with a plurality of data sets each of which corresponds to and is derived from attributes of wearable articles or accessories, wherein data sets are each derived as a two-dimensional data in said first predetermined viewing plane; and
a visual display module in communication with the processor module, for displaying the first visual representation in real time on a visual display module, and for providing a visual representation of at least a first wearable article or accessory corresponding to the at least one of the plurality of data sets, responsive to a predetermined threshold of correlation between the data derived from input of the first visual representation and at least one of the plurality of data sets.

21. A process according to claim 19, wherein the wearable article or accessory is an article of jewelry.

22. A process according to claim 19, wherein the wearable article or accessory selected from the group including clothing, footwear, headgear and handbags.

23. A system according to claim 20, wherein the wearable article or accessory is an article of jewelry.

24. A system according to claim 20, wherein the wearable article or accessory selected from the group including clothing, footwear, headgear and handbags.
